(19) United States
(12) Patent Application Publication
(10) Pub. No.: US 2011/0070923 A1
(43) Pub. Date: Mar. 24, 2011

(54) HANDHELD APPARATUS AND METHOD OF EXAMINING AND DRIVING A DETACHABLE SCREEN OF A HANDHELD APPARATUS

(76) Inventors: Guo-Qiang TANG, Shanghai City (CN); Hui-Fang Li, Shanghai City (CN); Tony Tsai, Taipei County (TW)

(21) Appl. No.: 12/887,240

(22) Filed: Sep. 21, 2010

(30) Foreign Application Priority Data
Sep. 22, 2009 (TW) 098131911

(51) Int. Cl. G09G 5/00; H04M 1/02

(52) U.S. Cl. 455/566; 345/204

(57) ABSTRACT

A handheld apparatus and a method of examining and driving a detachable screen of a handheld apparatus are provided. The handheld apparatus includes a detachable screen and a main body. The detachable screen can be contained by the main body. The detachable screen and the main body can be electrically coupled through a screen line interface and a main body line interface. The main body can access screen configuration data stored in the detachable screen to produce a screen configuration parameter, and drive the detachable screen according to the screen configuration parameter.

### CROSS-REFERENCE TO RELATED APPLICATION

This application claims the benefit of Taiwan Patent Application No. 098131911, filed on Sep. 22, 2009, which is hereby incorporated by reference for all purposes as if fully set forth herein.

### BACKGROUND OF THE INVENTION

1. Field of Invention

The present invention relates to a handheld apparatus and a method of examining and driving a detachable screen of a handheld apparatus, and more particularly to a handheld apparatus with a detachable screen, and a method for examining and driving the detachable screen of the handheld apparatus.

2. Related Art

Conventionally, when a handheld apparatus is assembled, the screen of the handheld apparatus is securely disposed in a housing therein. For safety reasons, electrical components and connection wires thereof are mounted on a circuit board by means of soldering. In addition, for the sake of portability, the manufacturer may reduce the size of the handheld apparatus according to customer requirements, so as to reduce the volume of the handheld apparatus.

However, the portability of the handheld apparatus may possibly accompany with a low durability of the handheld apparatus. For example, the screen of the handheld apparatus may damage due to falling, external impact, or moisture factors, and require for repairing. However, since the screen has been securely disposed in the housing of the handheld apparatus and the wirings of the electrical components of the handheld apparatus are associated with one another, the screen may not be able to be repaired or displaced once it is damaged, such that the handheld apparatus has to be scraped.

### SUMMARY OF THE INVENTION

Accordingly, the invention is directed to a handheld apparatus which includes a detachable screen and a main body, so that the screen can be displaced on occasion by or with another screen or a new screen, which can function normally.

The detachable screen includes a screen control module and a screen line interface. The screen control module is used for storing screen configuration data, and the screen line interface is electrically coupled to the screen control module.

The main body includes a main body control module, a containing portion, and a main body line interface. The main body control module includes a screen identification unit, the containing portion is used for containing the detachable screen. In an embodiment, the containing portion is also used for fixing the detachable screen. The main body line interface is electrically coupled to the main body control module, and configured to be electrically coupled to the screen line interface. And the main body control module has functions of using the screen identification unit to access the screen configuration data so as to produce a screen configuration parameter, and driving the screen control module according to the screen configuration parameter.

The invention is also directed to a method of examining and driving a detachable screen of a handheld apparatus, which is applicable to a handheld apparatus with a detachable screen to enable a substitute screen to function normally. The method includes the steps as follows: accessing screen configuration data stored in the detachable screen; examining the screen configuration data to produce a screen configuration parameter; and driving the detachable screen according to the screen configuration parameter.

The invention is characterized in that the handheld apparatus includes two members, that is, the main body and the detachable screen. Once the detachable screen is damaged, the damaged screen can be easily detached from the handheld apparatus and displaced by or with a new one, and the main body and related wirings are not affected at all during the attaching and detaching process. Therefore, a repair failure rate and a screen repair cost of the handheld apparatus may greatly be reduced. In addition, as long as the detachable screens are compatible with the main body in the specification, different styles of screens can be used according to user's requirements, thereby improving a diversity of the screen disposition of the handheld apparatus.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a handheld apparatus with a detachable screen according to an embodiment of the present invention;

FIG. 2 is a flow chart of a method of examining and driving a detachable screen of a handheld apparatus according to an embodiment of the present invention;

FIG. 3 is a perspective view of a handheld apparatus with a detachable screen according to an embodiment of the present invention; and

FIG. 4 is a flow chart of a step of examining and driving the detachable screen according to the present invention.

### DETAILED DESCRIPTION OF THE INVENTION

Preferred embodiments of the invention are described in detail below with reference to the accompanying drawings.

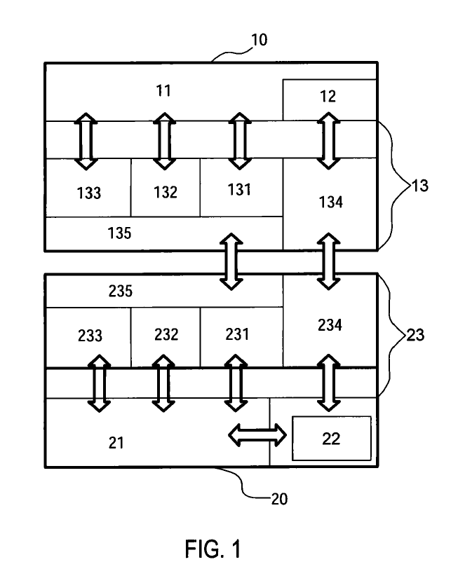

FIG. 1 is a block diagram of a handheld apparatus with a detachable screen according to an embodiment of the invention. Examples of the handheld apparatus according to embodiments of the invention may be a cell phone or a mobile communication device. Referring to FIG. 1, the handheld apparatus in this embodiment includes a detachable screen 10 and a main body 20. The detachable screen 10 includes a screen control module 11 and a screen line interface 13. The screen control module 11 is used for storing screen configuration data 12. The screen control module 11 may store the screen configuration data 12. The screen line interface 13 is electrically coupled to the screen control module 11, wherein the screen line interface 13 may be an interface allowing passage of lines, wires, or circuits, or accommodating connection between them. The main body 20 includes a main body control module 21, a containing portion 24 and a main body line interface 23. The main body control module 21 includes a screen identification unit 22. The containing portion 24 is used for containing the detachable screen 10. The containing portion 24 may contain the detachable screen 10, and may even be used for fixing the detachable screen 10.—The main body line interface 23 is electrically coupled to the main body control module 21, and configured to be electrically coupled to the screen line interface 13. The main body line interface 23 also may be an interface allowing passage of lines, wires, or circuits, or accommodating connection between them.

In an embodiment, a butt joint is capable of being formed between the main body line interface 23 and the screen line interface 13 which correspond to each other in structure. When the main body line interface 23 is electrically coupled to the screen line interface 13, the main body 20 and the detachable screen 10 are electrically coupled to each other, such that the main body 20 is enabled by the interfaces 23, 13 to control the detachable screen 10. The interfaces 23, 13 accommodate a pair of electrically coupled screen data lines (131, 231), a pair of electrically coupled screen control lines (132, 232), a pair of electrically coupled screen power control lines (133, 233), and a pair of electrically coupled device attribute reading units (134, 234).

The screen data lines (131, 231) may include 4-pin, 8-pin, 16-pin, or higher-pin-count specifications. According to the screen data lines (131, 231) of different specifications, the main body 20 can be connected to detachable screens 10 with different resolutions. For example, if the main body 20 has a screen data line specification of 8-pin, the main body 20 can be mounted with a 4-pin or an 8-pin detachable screen 10, and so on.

Through the screen control lines (132, 232), the main body 20 may control an operating clock and a timing characteristics (timer; including line-synchronizing and field-synchronizing screen display signal control) of the detachable screen 10, as well as electrical lines for controlling enabling of the screen.

The main body 20 may provide an operating bias required by an operation of the detachable screen 10 through the screen power control lines (133, 233). According to types of the connected detachable screens 10, the main body 20 provides different operating biases to meet power requirements of the detachable screens 10 for displaying images.

When the main body line interface 23 and the screen line interface 13 are electrically coupled, the main body control module 21 and the screen control module 11 are electrically coupled and can communicate with each other, and the two device attribute reading units (134, 234) are also electrically coupled to each other. The main body control module 21 has a function of using the screen identification unit 22 to access the screen configuration data 12, and the main body control module 21 then analyzes a content of the screen configuration data 12 to produce a screen configuration parameter. Herein, the screen identification unit 22 may have a function of comparing screen specification parameters with the screen configuration data 12, so as to obtain a qualified parameter serving as the screen configuration parameter. The main body control module 21 then has a function of driving the screen control module 11 of the detachable screen 10 according to the screen configuration parameter. The screen configuration parameters may contain device specifications of the detachable screen 10, which may include a resolution, a color depth, a data transmission format, an operating clock, an operating bias, or signal-synchronizing timing and frequency of the detachable screen 10.

The main body 20 may use the screen data lines (131, 231), the screen control lines (132, 232), and the screen power control lines (133, 233) to set the resolution, the color depth, the data transmission format, the operating clock, the operating bias, or the signal-synchronizing timing and frequency of the detachable screen 10, so as to effectively drive and control the operation of the detachable screen 10.

As shown in FIG. 1, the screen data line 231, the screen control line 232, and the screen power control line 233 of the main body line interface 23 are all connected to a main body bus interface 235. Likewise, the screen data line 131, the screen control line 132, and the screen power control line 133 of the screen line interface 13 are all connected to a screen bus interface 135. A butt joint is capable of being formed between the screen line interface 13 and the main body line interface 23 which correspond to each other in structure, such as a male and a female connector, or metal pin structures capable of being in contact to electrically couple the screen line interface 13 and the main body line interface 23. Lines of the two device attribute reading units (134, 234) are jointed to form a 1-Wire, Inter-Integrated Circuit (I2C), or other similar universal bus interfaces. However, in the physical structures, the male and female connector structures or the metal pin structures are often adopted so as to simplify the joint design of the main body line interface 23 and the screen line interface 13, but is not limited to.

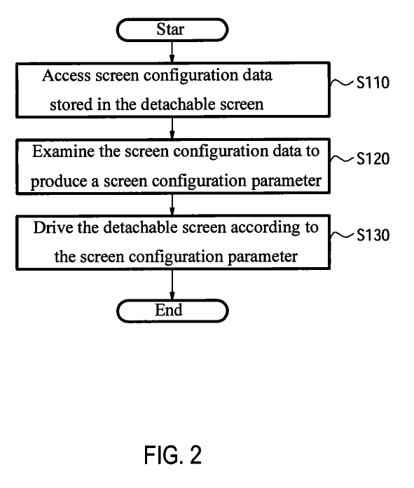

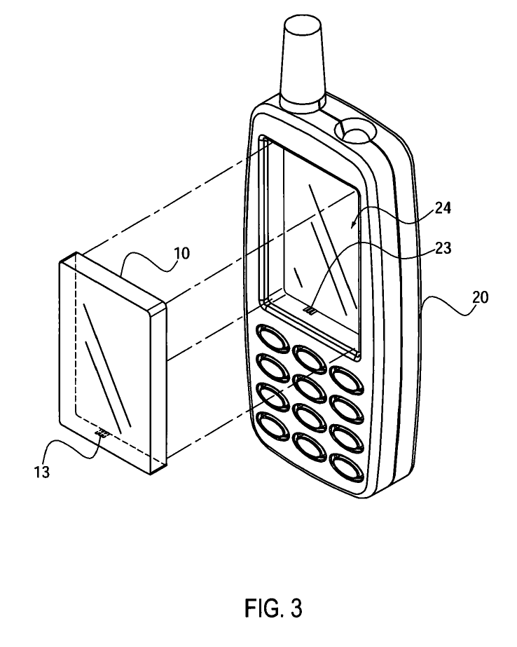

FIG. 2 is a flow chart of a method of examining and driving a detachable screen of a handheld apparatus according to an embodiment of the invention. Referring to FIG. 2, the method is applied to a handheld apparatus with a detachable screen 10. FIG. 3 is a perspective view of a handheld apparatus with a detachable screen according to an embodiment of the invention. Reference is made to FIGS. 1, 2, and 3, for the convenience of understanding. The method of examining and driving a detachable screen of a handheld apparatus is illustrated as follows.

Screen configuration data 12 stored in the detachable screen 10 is accessed (Step S110). In addition to the detachable screen 10, the handheld apparatus may also include the main body 20. In this embodiment of the method, the detachable screen 10 includes a screen control module 11 and a screen line interface 13. The screen configuration data 12 may be stored in the screen control module 11. The screen line interface 13 may be disposed on an external surface of the detachable screen 10, and have lines extending into the detachable screen 10, such that the screen line interface 13 may be electrically coupled to the screen control module 11.

In this embodiment of the method, the main body 20 may include a main body control module 21, a containing portion 24 and a main body line interface 23. The main body line interface 23 may be disposed inside of the containing portion 24, and have lines extending into the main body 20, such that the main body line interface 23 may be electrically coupled to the screen line interface 13. The containing portion 24 is used for containing the detachable screen 10, and may be disposed on a surface of the main body 20.

Referring to FIG. 3, the containing portion 24 may comprise a groove having an inside shape matching a shape of the detachable screen to enable the containing portion 24 to contain the detachable screen therein. The detachable screen 10 may be fixed in the containing portion 24 by a common fixing means.

In addition, the screen line interface 13 is disposed at a bottom position of the detachable screen 10, and the main body line interface 23 is disposed inside of the containing portion 24 at a position corresponding to the screen line interface 13. Moreover, the screen line interface 13 and the main body line interface 23 may have metal pin structures capable of being in contact to electrically couple the screen line interface 13 and the main body line interface 23. When the detachable screen 10 is fixed in the main body 20, the main body line interface 23 and the screen line interface 13 are connected, such that the main body control module 21 and the screen control module 11 are electrically coupled to each other. It should be noted that, the screen line interface 13 may be disposed at any external position of the detachable screen 10, as long as the position of the screen line interface 13 is corresponding to the position of the main body line interface 23.

When the handheld apparatus is turned on, the main body 20 initializes and boots the apparatus. After the two device attribute reading units (134, 234) are electrically coupled, a data transmission path is formed, so as to enable the main body control module 21 to communicate with the screen control module 11. The main body control module 21 has functions of using the screen identification unit 22 to access the screen configuration data 12 stored in the screen control module 11.

The screen configuration data 12 is examined to produce a screen configuration parameter (Step S120). The main body control module 21 examines the contents of the screen configuration data 12 so as to obtain a device attribute and a specification of the detachable screen 10, and produces the screen configuration parameter. Besides, the main body control module 21 drives and controls the operation the screen control module 11 of the detachable screen 10 according to an examined result. The screen configuration data 12 may include data about an image resolution, a color depth, a data transmission format, an operating clock, an operating bias, or signal-synchronizing timing and frequency of the detachable screen 10, as well as required data.

The detachable screen 10 is driven according to the screen configuration parameter (Step S130). The main body control module 21 transmits the screen configuration parameter to the detachable screen 10 through control lines formed by the main body line interface 23 and the screen line interface 13, so as to enable the screen control module 11 to configure and initialize the screen according to the screen configuration parameter.

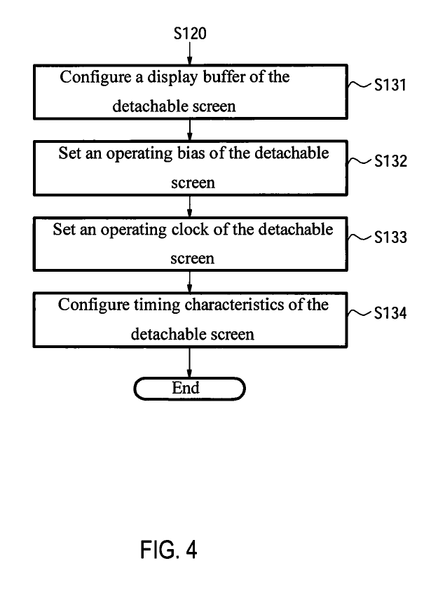

As shown in FIG. 4, the step of examining and driving the detachable screen 10 includes: (1) the main body control module 21 configures a display buffer of the detachable screen 10 through the screen data lines (131, 231) (Step S131). For example, for a pixel buffer, a frame buffer, and a display resolution buffer space of the detachable screen 10, a buffer memory required by the display resolution buffer space is “Resolution×(Color Depth/8)”. For example, if the detachable screen 10 has an image resolution of 320×240 and a color depth of 32 bits, the display resolution buffer space requires (320×240)×(32/8)=307200 bytes.

(2) The main body 20 sets an operating bias of the detachable screen 10 through the screen power control lines (133, 233) (Step S132). According to types of the connected detachable screens 10, the main body 20 provides different operating biases to meet power requirements of the detachable screens 10 for displaying images.

(3) Through the screen control lines (132, 232), the main body 20 sets an operating clock of the detachable screen 10 (Step S 133), and configures timing characteristics of the detachable screen 10 (Step S 134) (including line-synchronizing and field-synchronizing screen display signal control), as well as electrical lines for controlling enabling of the screen. Thus, the main body 20 completes the setting of the fixed detachable screen 10. Afterward, the main body 20 initializes other elements.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A handheld apparatus, comprising:
a detachable screen, comprising:
a screen control module, for storing screen configuration data; and
a screen line interface, electrically coupled to the screen control module; and
a main body, comprising:
a main body control module comprising a screen identification unit;
a containing portion, for containing the detachable screen; and
a main body line interface, electrically coupled to the main body control module, and configured to be electrically coupled to the screen line interface;
wherein the main body control module has functions of using the screen identification unit to access the screen configuration data so as to produce a screen configuration parameter, and driving the screen control module according to the screen configuration parameter.

2. The handheld apparatus according to claim 1, wherein a butt joint is capable of being formed between the screen line interface and the main body line interface which correspond to each other in structure.

3. The handheld apparatus according to claim 1, wherein the screen line interface and the main body line interface have metal pin structures capable of being in contact to electrically couple the screen line interface and the main body line interface.

4. The handheld apparatus according to claim 1, wherein the containing portion comprises a groove having an inside shape matching a shape of the detachable screen, to enable the containing portion to contain the detachable screen.

5. The handheld apparatus according to claim 4, wherein the main body line interface is disposed inside of the containing portion to be electrically coupled to the screen line interface.

6. The handheld apparatus according to claim 1, wherein the screen identification unit has a function of comparing screen specification parameters with the screen configuration data, so as to obtain a qualified parameter serving as the screen configuration parameter.

7. The handheld apparatus according to claim 1, wherein the screen configuration data comprise data about an image resolution of the detachable screen.

8. The handheld apparatus according to claim 1, wherein the screen configuration data comprise data about a color depth of the detachable screen.

9. The handheld apparatus according to claim 1, wherein the screen configuration data comprise data about an operating bias of the detachable screen.

10. The handheld apparatus according to claim 1, wherein the screen configuration data comprise data about an operating clock of the detachable screen.

11. The handheld apparatus according to claim 1, wherein the containing portion is used for fixing the detachable screen.

12. A method of examining and driving a detachable screen of a handheld apparatus, comprising:
accessing screen configuration data stored in the detachable screen;
examining the screen configuration data to produce a screen configuration parameter; and
driving the detachable screen according to the screen configuration parameter.

13. The method of examining and driving a detachable screen of a handheld apparatus according to claim 12, wherein the screen configuration data comprise data about an image resolution of the detachable screen.

14. The method of examining and driving a detachable screen of a handheld apparatus according to claim 12, wherein the screen configuration data comprise data about a color depth of the detachable screen.

15. The method of examining and driving a detachable screen of a handheld apparatus according to claim 12, wherein the screen configuration data comprise data about an operating bias of the detachable screen.

16. The method of examining and driving a detachable screen of a handheld apparatus according to claim 12, wherein the screen configuration data comprise data about an operating clock of the detachable screen.

17. The method of examining and driving a detachable screen of a handheld apparatus according to claim 12, wherein the step of driving the detachable screen according to the screen configuration parameter comprises:
configuring a display buffer of the detachable screen;
setting an operating bias of the detachable screen;
setting an operating clock of the detachable screen; and
configuring timing characteristics of the detachable screen.
